(19) United States
(12) Patent Application Publication
(10) Pub. No.: US 2004/0243493 A1
(43) Pub. Date: Dec. 2, 2004

(54) Method of determining a capital-at-risk for a clearing house

(76) Inventors: Bengt Jansson, Stockholm (SE); Erik Ricknell, Stockholm (SE)

Correspondence Address: NIXON & VANDERHYE, PC, 1100 N GLEBE ROAD, 8TH FLOOR, ARLINGTON, VA, 22201-4714, US

(21) Appl. No.: 10/445,297

(22) Filed: May 27, 2003

(51) Int. Cl. G06F 17/60

(52) U.S. Cl. 705/35

(57) ABSTRACT

In an algorithm for estimating the required capital-at-risk of the clearing capital used by a computer system the system will receive a number of positions for accounts associated with the clearing house and estimate the market value of the accounts at a number of different scenarios. The algorithm will then sum the accounts associated with the highest losses to a sum indicative of a potential loss, which sum will be used as the capital-at-risk for the clearing house.

### TECHNICAL FIELD

The present invention relates to a method and a system module for use in conjunction with a computerized clearing system, and in particular to a method and a system for determining the required clearing capital and more specifically the capital-at-risk for a clearing house.

### BACKGROUND OF THE INVENTION AND PRIOR ART

A clearing house, sometimes termed a clearing organization, is a facility guaranteeing that the commitments of two parties that have entered into a transaction are fulfilled even though one or both of these parties should default. In return the clearing house receives a small fee for every transaction making use of the clearing guarantee from the clearing house. In this regard a clearing house can be seen as an insurance company that ensures the completion of an entered transaction.

In order to be able to undertake this obligation the clearing house utilizes different risk mitigation techniques, such as calculating and collecting margin, also referred to as collateral, and an active risk management. In the event that a counterparty defaults, and the replacement of that counterparty's obligations leads to a loss, the clearing house use the posted margin, and other available resources as guarantees, to cover that loss.

In the event that collected margin of the defaulting counterparty, and possibly other resources relating to the counterparty (e.g. insurances), are not sufficient the clearing house has to cover the loss with its own resources. In order to present a viable impression the clearing house needs a clearing capital that is backing up the clearing guarantee of considerable amount.

The total clearing capital of the clearing house should cover very high losses, which can result if there are very rapid changes in the market particularly in a catastrophe scenario. In such a scenario a number of counterparties with an adverse position can be anticipated to have financial problems. On the other hand the capital should not be too large because assets are locked that could have a better use elsewhere.

Today, the amount of required clearing capital is usually determined ad hoc without a deeper analysis of the situation at hand. Due to this ad hoc approach the allotted clearing capital has to be a lot greater than, allegedly, actually needed. Also, the clearing capital is fix over long time periods, even though the market may undergo changes. Thus, one can presume that the actual clearing capital required could be significantly reduced without affecting the trust the market participants place in the clearing house.

Thus, there exist a need for a method and a system that is able to estimate the amount of required clearing capital more accurately in the event of a financial melt down. The estimated required clearing capital should be enough to cover losses of the clearing house in the event of a financial melt down. This potential loss can be termed the “capital-at-risk”. The amount of clearing capital should hence be at least equal to the capital-at-risk and preferably with addition of a buffer of suitable size.

### SUMMARY

It is an object of the present invention to provide a method and a system that can provide an estimated required capital-at-risk given a particular market situation, and which thereby enables the clearing house to minimize the capital used without reducing its chances to fulfil its obligations to a level not accepted by the market participants making use of the clearing house.

It is a further object of the present invention to provide a method and a system for determining a required capital-at-risk for a clearing house that can cope with rapid changes in the positions of the parties associated with the clearing house as well as changes in the market.

These objects and others are obtained by determining the required capital-at-risk using a model receiving input data from the actual positions taken by the parties utilizing the clearing house and that may also use historical data associated with the different contracts underlying the positions. The credit rating of the different parties can also be taken into account using the model as described herein.

The algorithm for estimating the required capital-at-risk of the clearing capital used by the system as described herein will receive a number of positions for accounts associated with the clearing house and estimate the market value of the accounts at a number of different scenarios. The algorithm will then sum the accounts associated with the highest losses to a sum indicative of a potential loss, which sum will be used as the capital-at-risk for the specific clearing house.

### BRIEF DESCRIPTION OF THE DRAWINGS

The present invention will now be described more in detail and with reference to the accompanying drawings, in which:

FIG. 1 is a view of a computer system for determining a capital-at-risk.

FIG. 2 is a flowchart illustrating steps performed when determining a current required capital-at-risk in the system as depicted in FIG. 1.

FIG. 3 is a flowchart illustrating steps performed when establishing scenarios for use in the algorithm as depicted in FIG. 2

### DETAILED DESCRIPTION

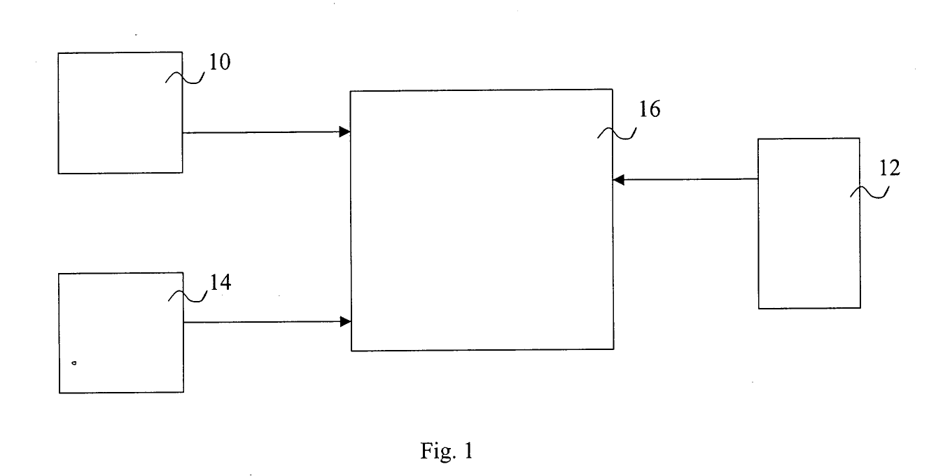

In FIG. 1, a view of a computer system for determining a clearing capital is shown. The computer system comprises a price module 10 for providing the system with market prices in real time, a database 12 comprising updated information of current positions, a database 14 for storing different user configurable parameters, and a calculation unit 16 connected to the price module 10, the database 12 and the database 14 for calculating a required capital-at-risk.

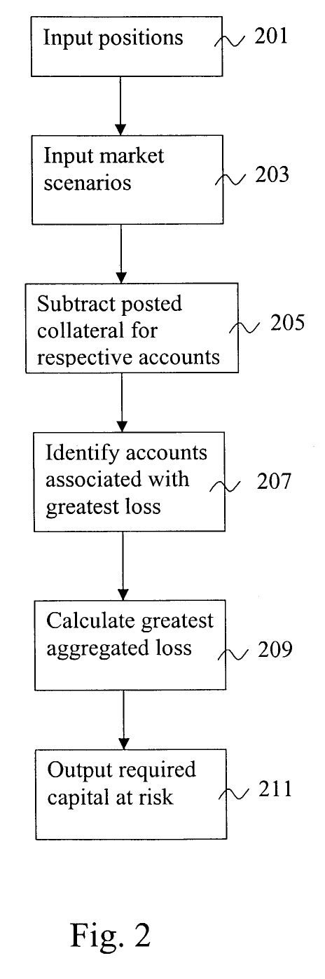

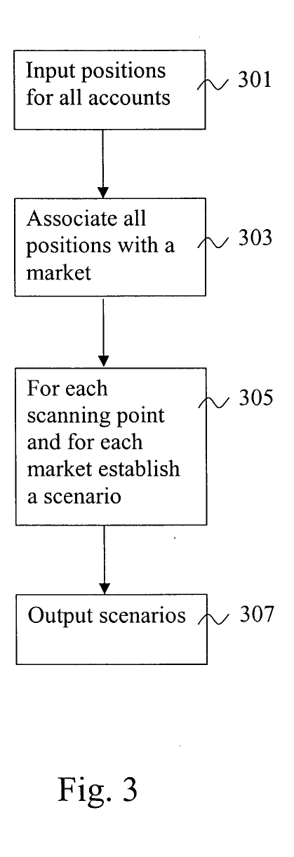

In FIG. 2, a flowchart illustrating steps performed when determining the clearing capital. First, in a block 201, the actual positions of all accounts associated with the system is input for a particular day. Next, in a block 203, a number of possible future market scenarios are input to the system. The scenarios can be established in a number of different ways, and some preferred ways will be described below in conjunction with FIG. 3.

Next, in a block 205, collateral posted for each account is subtracted from the respective accounts as resulting from the scenarios established in block 203. Thereupon, in a block 207, the accounts associated with the greatest loss are identified.

The accounts associated with the greatest loss as identified in block 207, are then summed into a calculated maximum aggregated loss in a block 209. The number of accounts used can range from only one to all accounts associated with a loss in the scenario. This number is set in accordance with user preferences and can for example be five. The aggregated loss as calculated in block 209 is then used in a block 211 as the required capital-at-risk for the clearing house.

In order for the algorithm as described above in conjunction with FIG. 2 to produce a result that is credible, the market scenarios input to the algorithm should take into account different possible market movements.

A straightforward way to create a scenario would be to scan each financial instrument in a range of possible movements and use every scanning point as a scenario. This would however quickly lead to a very high number of calculations, even in the case where the number of financial instruments is fairly low.

Thus, treating every single financial instrument separately would create processing problems not possible to solve with reasonable computer resources.

Instead the system as described herein makes use of a technique based on market movements. The technique relies on the fact that individual financial instruments in the same market tend to move together. In other words there exists a correlation between the price movements on instruments on the same market. This is in particular true in a catastrophe scenario such as a market crash.

In one exemplary implementation the markets are defined as one market for each country and type of financial instrument. E.g. a system handling positions in the U.S. and the U.K. and in the instruments types: stock, interest rate and electricity, would have six markets.

If processing power exists to process a larger number of scenarios, it would be easy to expand the number of markets to an arbitrary number of markets by sub-dividing each market into smaller markets, for example market sectors, with a higher correlation. For example in the example above the U.S. stock market could be divided into one market for pharmaceutical stocks, one for telecommunication stocks etc.

In order to further reduce the number of calculations the number of points at which each market is evaluated is preferably reduced to a minimum.

In FIG. 3, a flow chart illustrating steps for establishing the scenarios to be used is shown. First in a step 301 all positions of all accounts are input. Next, in a step 303 the positions are associated with a particular market. The precise manner in which each position is associated with a market can vary and is preferably set by the user and is also dependent on how a particular user has defined a market. Hence, if in the example above an account has a position in IBM stock it will be associated with the market labeled “U.S. stocks”.

Thereupon, in a step 305, each market will be evaluated at a number of different valuation points. This scanning of all markets is preferably only made at very few points, since the number of scenarios will increase dramatically with the number of point. The number of scenarios will be P^{M}, where P is the number of points and M is the number of markets. In a preferred embodiment the number of points is set to two, one offset above current market prices and one offset below the current market values.

Again, if there is processing power for more valuation points for each market than two a user may want to have scenarios for those as well. It is however a fair assumption that the greatest defaults will occur when the markets move to an end position and not there-in-between, even if this can occur. A possible set of valuation points can for example be +/−50% of the current market values. The scenarios are then output for use in the algorithm of FIG. 2 in a step 307.

Below some examples how the algorithm and system can be used in practice are given. Assume a number of markets A, B and C. The markets are all valued at +/−50% of the current market value. It would be possible to set different valuation points for different markets. A reason not to change this per market is that the parameters applied on different markets should reflect the same level of risk. If however by some reason a specific market has parameters set on a different risk level a different scanning point can and should be used.

It should be noted that the setting of valuation points can be made more sophisticated and in a manner that is computationally efficient as will discussed later in this description.

| | | Market A | | Market B | | Market C | |
|---|---|---|---|---|---|---|---|
| Account | Margin | −50% | 50% | −50% | 50% | −50% | 50% |
| AB 123 | −5 | −20 | 15 | −45 | 50 | 50 | −5 |
| AB 124 | −25 | 10 | −2 | 25 | −45 | 30 | −30 |
| BA 123 | −12 | 5 | −2 | 50 | −39 | −40 | 12 |
| CA 123 | −40 | −5 | 2 | −7 | 1 | 10 | −1 |
| CA 124 | −12 | 14 | −9 | 7 | −15 | 17 | −17 |
| CB 123 | −10 | 4 | −6 | 2 | −5 | 6 | −8 |
| CC 123 | −3 | 8 | −1 | −1 | 2 | 7 | −4 |
| DA 111 | −20 | −26 | 0 | −44 | 11 | −6 | 1 |
| DD 123 | −8 | 0 | −5 | 2 | 0 | 5 | −5 |
| XX 123 | 2 | 7 | −5 | −4 | 1 | 5 | −6 |

In the above table the result of a fictive test run is shown. There are three markets A, B and C together with 10 accounts. Each account also has a margin claim. Negative numbers are accumulated losses to the account. This means that negative margin numbers represent claims that has been pledged to the clearing house of at least that amount. Start with calculating the sum for each account given each possible scenario. There are three markets with two possible movements (+/−50%) each. This makes 8 scenarios, which are listed below, in a new table.

| | Scenario No. | | | | | | | |
|---|---|---|---|---|---|---|---|---|
| Account | 1 | 2 | 3 | 4 | 5 | 6 | 7 | 8 |
| A | 50 | 50 | 50 | 50 | −50 | −50 | −50 | −50 |
| B | 50 | 50 | −50 | −50 | 50 | 50 | −50 | −50 |
| C | 50 | −50 | 50 | −50 | 50 | −50 | 50 | −50 |
| AB 123 | 60 | 115 | −35 | 20 | 25 | 80 | −70 | −15 |
| AB 124 | −77 | −17 | −7 | 53 | −65 | −5 | 5 | 65 |
| BA 123 | −29 | −81 | 60 | 8 | −22 | −74 | 67 | 15 |
| CA 123 | 2 | 13 | −6 | 5 | −5 | 6 | −13 | −2 |
| CA 124 | −41 | −7 | −19 | 15 | −18 | 16 | 4 | 38 |
| CB 123 | −19 | −5 | −12 | 2 | −9 | 5 | −2 | 12 |
| CC 123 | −3 | 8 | −6 | 5 | 6 | 17 | 3 | 14 |
| DA 111 | 12 | 5 | −43 | −50 | −14 | −21 | −69 | −76 |
| DD 123 | −10 | 0 | −8 | 2 | −5 | 5 | −3 | 7 |
| XX 123 | −10 | 1 | −15 | −4 | 2 | 13 | −3 | 8 |

The table above shows all 8 scenarios per account. This represents the market value of the account given the scenario, respectively. It is seen that typically negative numbers occur for half of the scenarios and positive for the other half due to the fact that a transaction typically has one winner and one loser (zero-sum game). But this is not the whole picture. If an account have a negative margin this should be deducted from these numbers because this amount has already been pledged and will bring the exposure down. A positive margin on the other hand will not effect the exposure and will be set to zero in the calculations. The result is shown in the table below.

| | Scenario No. | | | | | | | |
|---|---|---|---|---|---|---|---|---|
| Account | 1 | 2 | 3 | 4 | 5 | 6 | 7 | 8 |
| A | 50 | 50 | 50 | 50 | −50 | −50 | −50 | −50 |
| B | 50 | 50 | −50 | −50 | 50 | 50 | −50 | −50 |
| C | 50 | −50 | 50 | −50 | 50 | −50 | 50 | −50 |
| AB 123 | 65 | 120 | −30 | 25 | 30 | 85 | −65 | −10 |
| AB 124 | −52 | 8 | 18 | 78 | −40 | 20 | 30 | 90 |
| BA 123 | −17 | −69 | 72 | 20 | −10 | −62 | 79 | 27 |
| CA 123 | 42 | 53 | 34 | 45 | 35 | 46 | 27 | 38 |
| CA 124 | −29 | 5 | −7 | 27 | −6 | 28 | 16 | 50 |
| CB 123 | −9 | 5 | −2 | 12 | 1 | 15 | 8 | 22 |
| CC 123 | 0 | 11 | −3 | 8 | 9 | 20 | 6 | 17 |
| DA 111 | 32 | 25 | −23 | −30 | 6 | −1 | −49 | −56 |
| DD 123 | −2 | 8 | 0 | 10 | 3 | 13 | 5 | 15 |
| XX 123 | −10 | 1 | −15 | −4 | 2 | 13 | −3 | 8 |

The table above can now be adjusted for possible rating figures. In this example it is assumed that the parties are associated with the credit rating as given in the table below and with the corresponding reduction of capital-at-risk. The reduction applied for different ratings can preferably be tuned by a user as a user set parameter of the system.

| | | Part of original capital at |
|---|---|---|
| | | risk that will be included in |
| Account | Rating | calculations (%) |
| AB 123 | AAA | 50% |
| AB 124 | AA | 51% |
| BA 123 | AA | 51% |
| CA 123 | BBB | 80% |
| CA 124 | BBB | 80% |
| CB 123 | Not rated | 100% |
| CC 123 | Not rated | 100% |
| DA 111 | Not rated | 100% |
| DD 123 | Not rated | 100% |
| XX 123 | Not rated | 100% |

Using the numbers in the table above will result in the table below.

| | Scenario No. | | | | | | | |
|---|---|---|---|---|---|---|---|---|
| Account | 1 | 2 | 3 | 4 | 5 | 6 | 7 | 8 |
| A | 50 | 50 | 50 | 50 | −50 | −50 | −50 | −50 |
| B | 50 | 50 | −50 | −50 | 50 | 50 | −50 | −50 |
| C | 50 | −50 | 50 | −50 | 50 | −50 | 50 | −50 |
| AB 123 | 32.50 | 60.00 | −15.00 | 12.50 | 15.00 | 42.50 | −32.50 | −5.00 |
| AB 124 | −52.00 | 8.00 | 18.00 | 78.00 | −40.00 | 20.00 | 30.00 | 90.00 |
| BA 123 | −17.00 | −69.00 | 72.00 | 20.00 | −10.00 | −62.00 | 79.00 | 27.00 |
| CA 123 | 21.42 | 27.03 | 17.34 | 22.95 | 17.85 | 23.46 | 13.77 | 19.38 |
| CA 124 | −14.79 | 2.55 | −3.57 | 13.77 | −3.06 | 14.28 | 8.16 | 25.50 |
| CB 123 | −7.20 | 4.00 | −1.60 | 9.60 | 0.80 | 12.00 | 6.40 | 17.60 |
| CC 123 | 0.00 | 8.80 | −2.40 | 6.40 | 7.20 | 16.00 | 4.80 | 13.60 |
| DA 111 | 32.00 | 25.00 | −23.00 | −30.00 | 6.00 | −1.00 | −49.00 | −56.00 |
| DD 123 | −2.00 | 8.00 | 0.00 | 10.00 | 3.00 | 13.00 | 5.00 | 15.00 |
| XX 123 | −10.00 | 1.00 | −15.00 | −4.00 | 2.00 | 13.00 | −3.00 | 8.00 |

This table above is the final result of the calculations and is now used to estimate needed capital under different assumptions.

Example. Calculate the capital-at-risk under the assumption that it must cover the default of 20% of the accounts. In this case with 10 accounts, take out the two worst accounts for each scenario, do notice that positive values are set to zero since only losses are of interest:

| | Scenario No. | | | | | | | |
|---|---|---|---|---|---|---|---|---|
| | 1 | 2 | 3 | 4 | 5 | 6 | 7 | 8 |
| 1 | −52.00 | −69.00 | −23.00 | −30.00 | −40.00 | −62.00 | −49.00 | −56.00 |
| 2 | −17.00 | 0.00 | −15.00 | −4.00 | −10.00 | −1.00 | −32.50 | −5.00 |
| Sum | −69.00 | −69.00 | −38.00 | −34.00 | −50.00 | −63.00 | −81.50 | −61.00 |

The worst scenario is in this example scenario No. 7 (A −50%, B −50% and C+50%) with accounts DA111 and AB123 giving a loss of −81.50. The capital-at-risk for these 10 accounts with the parameters set as above will then be 81.50. In these calculations positive values are set to zero. Do notice that it could be different accounts for each scenario.

In yet another preferred embodiment the valuation points are selected based on the amount of margin collected for the respective market. For example if for a particular market the collateral is set to a value, a margin value, say 20% of the market value, the valuation points are selected in a range correlated to the margin value. For example, the valuation points can be selected in a range set to +/−150% of the valuation points in the margin calculations. In this example, where only two evaluation points are used for each market the valuation points will be set to +/−30% of the current market value.

One reason for making the valuation points dependent on the amount of margin collateral posted for a particular market is that the margin reflects the volatility of the market if the margin, as is common, is dependant on the volatility of the market. Thus, the extreme valuation points are offset by a greater value in markets with a high volatility than in markets with a low volatility. Another way to select the valuation points would therefore be to set the extreme valuation points based on the volatility for each market, i.e. the historical market movements for each particular market or market sector if market sectors are used.

There are advantages to use the same portfolio valuation in the Capital-at risk calculations as in the margin calculations because the same conventional margin calculations can be made for these different values and the calculations only need to be made once, since the same values can be used for both the margin calculation and as a basis for the capital-at risk calculation.

Moreover, besides saving computation and hence the computational load on the computer used, also fewer parameters need to be set compared to if two different portfolio valuation methods were to be employed.

The method and system as described herein will further provide a user-friendly software implemented solution for providing a capital-at-risk for a clearing house. The capital-at-risk calculations are made flexible and can be made with a complexity possible to carry out with a conventional computer system having reasonable processing power.

What is claimed is:

1. A method of determining the capital-at-risk required by a clearing house comprising the steps of:
a) inputting positions for accounts associated with the clearing house,
b) determining the market value of the accounts at a number of valuation points,
c) summarizing accounts associated with losses to a sum indicative of a potential loss,
d) outputting said sum as the required capital-at-risk.

2. The method of claim 1, wherein in step c) only a selection of accounts is summed into a potential loss.

3. The method of claim 1, wherein the loss for a particular account is adjusted based on a credit rating established for the holder of said particular account.

4. The method of claim 1, wherein the valuation points are based on a potential offset of a number of markets.

5. The method of claim 4, wherein additional evaluation points are formed based on potential offsets in a number of sub-markets.

6. The method of claim 1, when more than one set of evaluation points are evaluated, wherein the set of evaluation points providing the greatest loss is used as output sum.

7. The method of claim 1, wherein the potential loss is adjusted by margin posted by the holder of an account.

8. The method according to claim 3, wherein the size of adjustment for a particular credit rating is a user defined parameter.

9. The method according to claim 1, wherein the range in which said evaluation points are located within a range derived from the current market value.

10. The method according to claim 4, wherein the offset of the valuation points are correlated to the posted collateral margins for each market.

11. The method of claim 1, when the capital-at-risk calculations are made in conjunction to calculations related to margins for a number of portfolios, wherein the same margin calculations made for a portfolio are used as a basis for the capital-at-risk calculations.

12. A computer system for determining the capital-at-risk required by a clearing house, the system having:
a module for storing positions for accounts associated with the clearing house,
a unit for determining the market value of the accounts at a number of valuation points,
a unit for summarizing accounts associated with losses to a sum indicative of a potential loss, and
a computer output source for outputting said sum as the required capital-at-risk.

13. The system of claim 12, wherein in the market value determining unit is set to sum only a selection of accounts into a potential loss.

14. The system of claim 12, further having a module set to adjust the loss for a particular account based on a credit rating established for the holder of said particular account.

15. The system of claim 12, wherein the market value determining unit is set to determine the valuation points based on a potential offset of a number of markets.

16. The system of claim 15, wherein the market value determining unit is set to form additional evaluation points based on potential offsets in a number of sub-markets.

17. The system of claim 12, when more than one set of evaluation points are evaluated, wherein the set of evaluation points providing the greatest loss is used as output sum.

18. The system of claim 12, wherein the potential loss is adjusted by margin posted by a holder of an account.

19. The system according to claim 14, wherein the size of adjustment for a particular credit rating is a user defined parameter.

20. The system according to claim 12, wherein the range in which said evaluation points are located are within a range derived from the current market value.

21. The system according to claim 15, wherein the offset of the valuation points are correlated to the posted collateral margins for each market.

22. The system of claim 12, wherein the system is set to perform the capital-at-risk calculations in conjunction to calculations related to margins for a number of portfolios, and wherein the same margin calculations made for a portfolio are used as a basis for the capital-at-risk calculations.
